(19) United States
(12) Patent Application Publication
(10) Pub. No.: US 2007/0106645 A1
(43) Pub. Date: May 10, 2007

(54) Legal database searching

(76) Inventor: Suzanne Nyhan Anthoney, Naperville, IL (US)

Correspondence Address: Paul E. Schaafsma;NovusIP, LLC, Suite 221, 521 West Superior Street, Chicago, IL, 60610-3135, US

(21) Appl. No.: 11/271,000

(22) Filed: Nov. 10, 2005

(51) Int. Cl. G06F 17/30

(52) U.S. Cl. 707/3

(57) ABSTRACT

In accordance with the principles of the present invention, a method of searching legal databases is provided. Pluralities of pre-selected fields are provided. The pre-selected fields are selected from a group of substantive subjects and selected from a group of case information. A matrix of the pre-selected field attributes comprises on a first axis parameters selected from a group of substantive subjects and on a second axis parameters selected from a group of case information. In addition, the database can be searched based on a search term in text. The results of the search term search are displayed results based on the frequency with which the search criterion appears in the text.

### FIELD OF THE INVENTION

The present invention relates to searching legal databases.

### BACKGROUND OF THE INVENTION

Legal research has progressed from the old stereotype of a huddled counsellor holed up in a dank legal library with mounds of legal reporters scattered about on the table. For more than a century, West Publishing Co. and West Publishing Corp. (collectively “West”) have been compiling and reporting opinions of state and federal courts. West is currently owned by The Thomson Corporation, Metro Center, One Station Place, Stamford, Conn. 06902. West publishes these opinions in a series of books known as the “National Reporter System.” Before it publishes an opinion, West checks the accuracy of case and statutory citations in the opinion and adds parallel citations, prepares headnotes (which summarize the specific points of law recited in each opinion) and a syllabus (which digests the opinion's general holdings) for the opinion, and assigns key numbers (which categorize points of law into different legal topics and subtopics). West then assigns its report of each opinion to one of the individual series in the National Reporter System, such as Federal Reporter, Third Series or the Bankruptcy Reporter; this assignment is based on the court and/or the subject matter of the opinion. Next, West assigns the case to a volume in the series, further categorizes and arranges the cases within the volume, and prepares additional materials, such as indices and tables of cases, for each volume.

The headnotes are created by staff attorney editors at West, who read the case and select the important issues of law. The headnotes are typically found at the beginning of each opinion. For example, the third headnote of a famous U.S. Supreme Court opinion, Gideon v. Wainwright, 372 U.S. 335, states:
“3. Constitutional Law 268.2 Sixth Amendment to federal Constitution providing that in all criminal prosecutions the accused shall enjoy right to assistance of counsel for his defense is made obligatory on the states by the Fourteenth Amendment, and indigent defendant in criminal prosecution in state court has right to have counsel appointed for him. Betts v. Brady, 316 U.S. 455, 62 S.Ct 1252, overruled. U.S.C.A.Const. Amends, 6, 14.”
   Thus, this headnote describes one major issue in the case: whether an indigent defendant in a criminal prosecution in state court has the right to have counsel appointed for him. The broad topic assigned is “Constitutional Law,” the key number is 268.2.

The first successful experiments in what is now called “computer-assisted legal research” (CALR) were performed in the late 1950s and early 1960s by John Horty, Director of the University of Pittsburgh Health Law Center and (from 1960) an adjunct professor at the University of Pittsburgh School of Law. In an effort to facilitate research into the public health laws of Pennsylvania, Horty had the texts of relevant statutes coded onto punch-cards and then put on computer tapes where they could be searched and retrieved by keyword (technically “Key Words in Combination” or KWIC). In 1960, Horty demonstrated his system at the Annual Meeting of the American Bar Association.

Horty's system had significant technical limitations. In 1967, these limitations prompted the Ohio State Bar Association to create a not-for-profit corporation called Ohio Bar Automated Research (OBAR), which in turn contracted with an Ohio company called Data Corporation for the development of an improved variety of legal research software. In 1969, Data Corporation was acquired by Mead Corporation; a subsidiary of the latter, Mead Data Central, continued the OBAR project and eventually acquired all rights to it from OBAR itself. By 1972, Mead Data Central had produced a second-generation version of the OBAR software which retained many of the features of the Horty system. In April 1973, a modified version of this software was introduced to the American legal community under the name Lexis® service. The Lexis® service initially offered its subscribers a database of full-text federal statutes and case law, a federal tax library, and selected state databases.

While the initial Lexis® service utilized large, dedicated computers printing on heat sensitive paper, with the introduction of the personal computer into the legal environment and the evolution of the Internet, the service was soon offered to personal computer users over the Internet—for example, the IBM Corporation, 1133 Westchester Avenue, White Plains, N.Y. 10604 USA launched their first personal computer in 1981. The Lexis® service utilized full-text KWIC and Boolean logic searching. Boolean logic is named after Irish mathematician George Boole, who while at the University College Cork first defined an algebraic system of logic in the mid Nineteenth century. The main operations on a Boolean algebra are referred to as “and”, “or”, and “not.” Thus, the quality of the results being highly dependent on the user's grasp of this special form of logic.

The same year that the Lexis® service went on-line, the West Publishing Company began work on a CALR system of its own called Westlaw®. The first Westlaw® service—based on West's headnotes—went into operation in April 1975, but it was not until December 1976 that West undertook a full text service. Despite the addition of the West headnotes, the Westlaw® service also relied on use of Boolean logic. Indeed, both the Lexis® service and Westlaw® service continue to rely on this logic and the quality of the results is still highly dependent on the user's grasp of this special form of logic.

What would thus be advantageous would be to provide a more intuitive approach to searching legal precedent. It would still further be advantageous for this approach to enable practitioners in a given legal specialty field to quickly and efficiently search legal precedent in their given area of specialization.

### SUMMARY OF THE INVENTION

A method of searching legal databases in accordance with the principles of the present invention provides a more intuitive approach to searching legal precedent. A method of searching legal databases in accordance with the principles of the present invention enables practitioners in a given legal specialty field to quickly and efficiently search legal precedent in their given area of specialization.

In accordance with the principles of the present invention, a method of searching legal databases is provided. Pluralities of pre-selected fields are provided. The pre-selected fields are selected from a group of substantive subjects and selected from a group of case information. A matrix of the pre-selected field attributes comprises on a first axis parameters selected from a group of substantive subjects and on a second axis parameters selected from a group of case information. In addition, the database can be searched based on a search term in text. The results of the search term search are displayed results based on the frequency with which the search criterion appears in the text.

### BRIEF DESCRIPTION OF THE DRAWINGS

FIG. 1 is a schematic of a non-limiting example hardware architecture that can be used to run the system of the present invention.

FIG. 2 shows a navigation column in accordance with the principles of the present invention.

FIG. 3 shows an abstract search screen in accordance with the principles of the present invention.

FIG. 4 shows the abstract search screen of FIG. 3 with a legal specialty a drop down menu in accordance with the principles of the present invention.

FIG. 5 shows an example of a completed abstract search screen of FIG. 3.

FIG. 6 shows an example answer table in accordance with the principles of the present invention.

FIG. 7 shows an example case abstract in accordance with the principles of the present invention.

FIG. 8 shows a second example of a completed abstract search screen of FIG. 3.

FIG. 9 shows an answer table for the second example completed abstract search screen of FIG. 8.

FIG. 10 shows a case abstract for the second example completed abstract search screen of FIG. 8.

FIG. 11 shows a case title search screen in accordance with the principles of the present invention.

FIG. 12 shows an example of a completed case title search screen of FIG. 11.

FIG. 13 shows an answer table for the example case title search screen of FIG. 12.

FIG. 14 shows a case information screen for the example case title search screen of FIG. 12.

FIG. 15 shows an abstract text search page in accordance with the principles of the present invention.

FIG. 16 shows an answer table for the example abstract text search page of FIG. 15.

FIG. 17 shows a case title word search screen in accordance with the principles of the present invention.

### DETAILED DESCRIPTION OF THE PREFERRED EMBODIMENTS

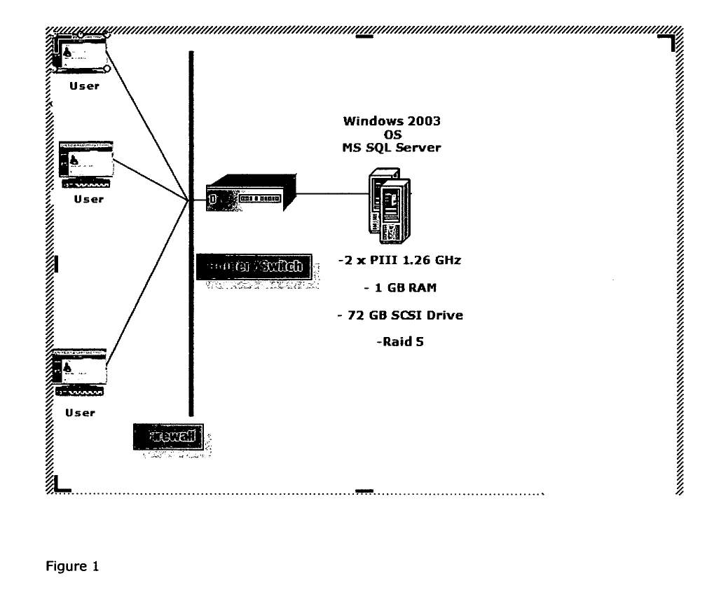

Referring to FIG. 1, a non-limiting example of a hardware infrastructure that can be used to run the system of the present invention is seen. In one embodiment, the infrastructure can include but is not limited to: 2 x Pentium III processor 1.26 gigahertz (GHz) central processing unit (CPU) available from Intel Corporation, 2200 Mission College Boulevard, Santa Clara, Calif. 95052 with 1 gigabit random access memory (GB RAM), a 72 GB small computer system interface (SCSI) drive, redundant array of independent disks (RAID) level 5. High-speed internet connectivity, routers, backup power, network backup hardware and firewalls can also be provided.

The application can be a “thin” client, “fat” server CLIENT/SERVER application. The application is “thin” in that the browser does little work besides display and it is “fat” in that the server does substantially all the work and transmits the results. The access method for display (GUI) can be a web browser such as for example the Mozilla or Firefox web browsers available from Mozilla Foundation, 1981 Landings Drive, Building K, Mountain View, Calif. 94043, or the Netscape web browser available from Netscape Communications Corp., 466 Ellis Street, Mountain View, Calif. 94043 as opposed to a stand-alone desktop application. The operating system can be Microsoft MS 2003 Standard Edition available from Microsoft Corporation, One Microsoft Way, Redmond, Wash. 98052. The server application can be Microsoft MS SQL also available from Microsoft Corporation. The system is able to run Clustered Application Server Technology with Fail Over Technology. Protocols used can include HTTP (hypertext mark up), HTTPS (secure hypertext mark up), FTP (file transfer protocol), JSP java server protocol), CFM (cold fusion mark up), and Java Script (browser control). Graphics technology used can include JPG, GIF, PNG.

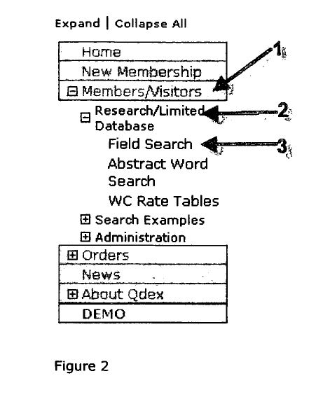

A navigation column is preferably provided on the various screens. To initiate a search, on the main menu in the navigation column, a members/visitors drop down is selected. Referring to FIG. 2, the navigation column is seen. Three choices appear: Research, Search Examples, and Administration. Research can be selected revealing Field Search, Abstract Word Search, and WC Rate Tables. To initiate a search based on pre-selected fields attributes, the Field Search is selected.

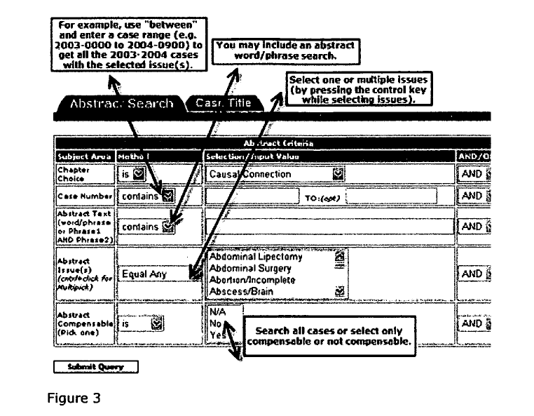

Referring to FIG. 3, an abstract search screen is seen. Initially, the search parameters, method of searching, selection/input value, and the and/or option are selected. The abstract search screen can include as columns subject area, method, selection/input value, and and/or having a default of and. The abstract search screen can include as rows chapter choice, case number, abstract text, abstract issue(s), and abstract compensable.

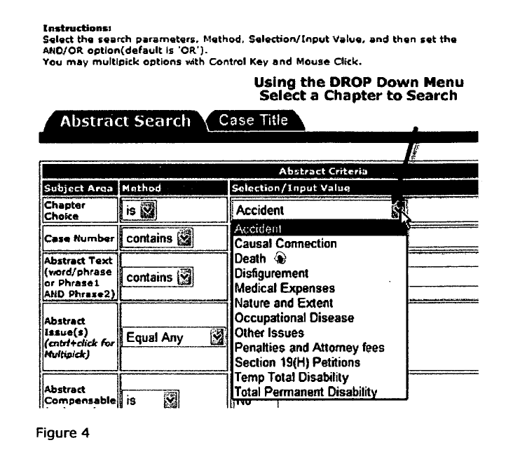

The abstract can be searched based on a selected legal specialty chapter. In the method and chapter choice cell, a drop down menu is provided having as one choice is. In the selection/input value and chapter choice cell, a drop down menu is provided having legal specialty chapters. In the example embodiment, the legal specialty chapters are workman's compensation chapters such as, for example, accident, causal connection, death, disfigurement, medical expenses, nature and extent, occupational disease, other issues, penalties and attorneys fees, section 19(H) Petitions, temp total disability, and total permanent disability. This is seen in FIG. 4. Thus, the user can select a legal specialty chapter to search.

Case number search criteria can be selected. In the case number and method cell, a drop down menu includes the choices contains, between, is, is not, before, and after. In the case number selection input value, a range can be entered. Thus, the user can add to the search criteria a case range based on the chosen criteria such as all cases in a specified time period.

In the abstract text and method cell, a drop down menu has as one choice contains. The user can add a search term in the abstract text and selection/input value cell. Thus, the user can add to the search criteria a search term in the abstract.

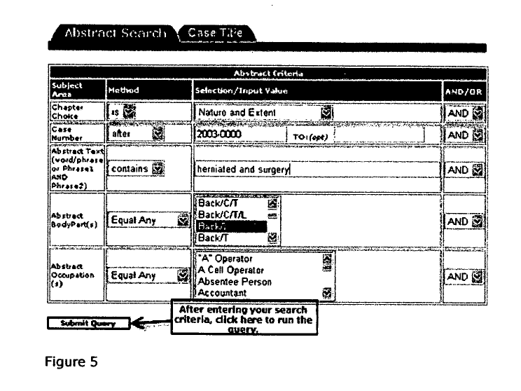

In the abstract issue(s) and method cell, a drop down menu has as choices equal any and not equal any. The abstract issue(s) and selection/input value cell has a scroll list with a plethora of legal specialty issues. These legal specialty issues are comprised of issues related to the chosen legal specialty chapter. In the example of FIG. 3, if the chosen legal specialty chapter is causal connection the related legal specialty issues can include, for example, abdominal lipectomy, abdominal surgery, abortion/incomplete, abscess/brain, abscesses/subungual, abscesses/throat, Achilles tendonitis, Achilles tender tear, acne vagaris, acne/cystic, acne/steroid, acromioclavicular injury, acromioplasty, etc. In the example of FIG. 4, if the chosen legal specialty chapter is accident the related legal specialty issues can include, for example, abuse/verbal, accident description, acid flumes inhalation, acquiescence, acromioplasty, act of god, adjusting chair, after hours, air turbulence, alcohol consumption, allergic reaction, altered records, alternative theories, anamalous muscles, anaphylactic reaction, aneurism, aneurism rupture, angina, etc. In the example of FIG. 5, if the chosen legal specialty chapter is nature and extent the related legal specialty issues can include abdomen, abdomen/groin, abdomen/liver, arm, arm & leg, arm/elbow, arm/hand, arm/shoulder, arm/thumb, arm/wrist, back, back/c, back/c/t, back/c/t/l/, back/t, etc. Multiple issues can be selected by use of a computers control keys and mouse click as known. Thus, the user can add to the search criteria which issues to search the abstract.

The abstract compensable and method cell has a drop down menu with as choices is and is not; the default is both “is and is not” so that both compensable and not-compensable cases are selected by default if no choice is elected. The abstract compensable selection/input value cell has three choices: N/A, no, and yes. Thus, the user can select to search all cases or only compensable or not compensable cases. Referring to FIG. 5, an example of a completed abstract search screen is seen. In this example the system will select all abstracts for cases after 2003 involving the low back, a herniation, and some reference to surgery. Submit query is selected to initiate the search.

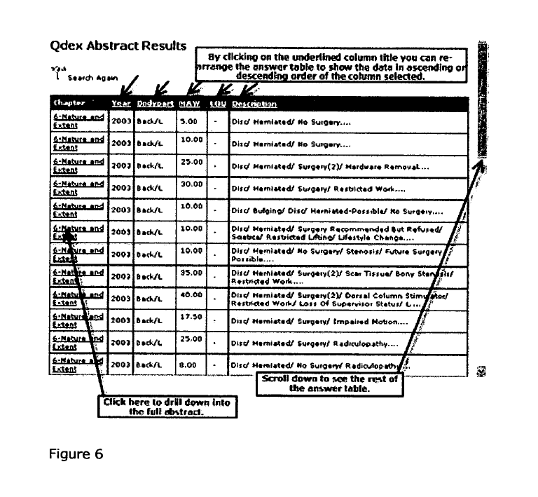

Upon completion of the search, an answer table is created. An example answer table is seen in FIG. 6. The answer table can include as columns legal specialty items such as, for example, chapter, year, body part, MAW (man as a whole), LOU (loss of use), and description. The answer table can include as rows selected cases. By selecting an underscored column title the answer table can be rearranged to show the data in ascending or descending order of the column selected. A scroll can be provided to scroll the remainder of the page if the search results are too numerous to fit on one screen. At the end of the answer table a line states “version (#)” which indicates the number of answers in the table (the number of answers that met the query criteria). To initiate a new search, search again can be selected.

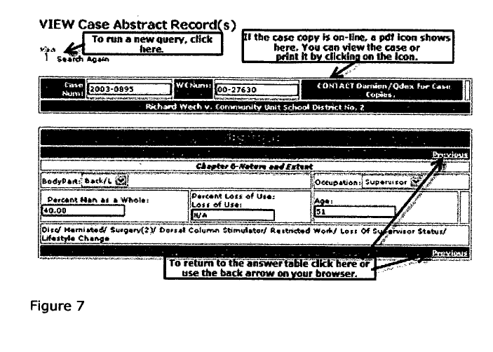

By selecting a case, the full abstract can be displayed. Referring to FIG. 7, an example case abstract is seen. The abstract can include as general fields legal specialty information such as, for example, the case number, workers compensation number, and title. The abstract can include as specific fields information specific to the search parameters such as, for example, body part, percent man as a whole, percent loss of use, occupation, and age. If a copy of the case is on-line, an icon will appear that can be selected to display the entire case; if the case is not on-line, as in FIG. 7, instructions on how to obtain a copy of the case can be provided. To return to the answer table a previous link or a back arrow of a computer can be selected as shown.

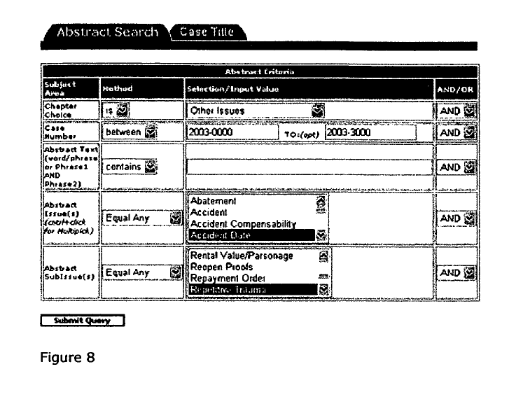

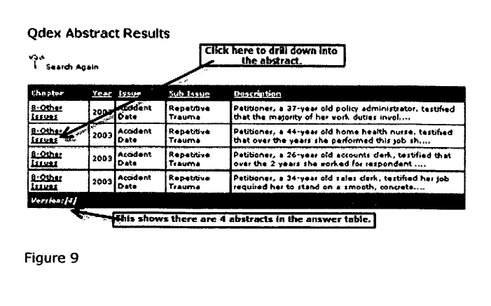

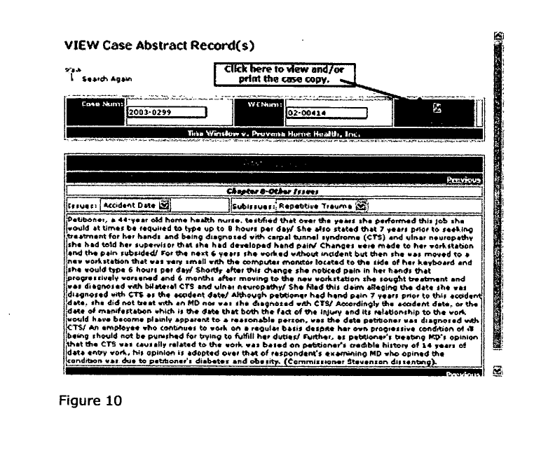

Referring to FIG. 8, a second example of a completed abstract search screen is seen. In this example the system will select all 2003 case abstracts with accident date as the issue and repetitive trauma as the sub-issue. Again, submit query is selected to initiate the search. An answer table for this second example is seen in FIG. 9. In this example, a scroll feature is not provided as the entire search results fit on one screen. By selecting a case, the full abstract can be displayed. Referring to FIG. 10, a case abstract for this second example is seen. In contrast to the first example, in this second example a copy of the case is on-line, an icon appears that can be selected to display the entire case, and the full abstract is set forth. By selecting the icon, the full text of the case is displayed.

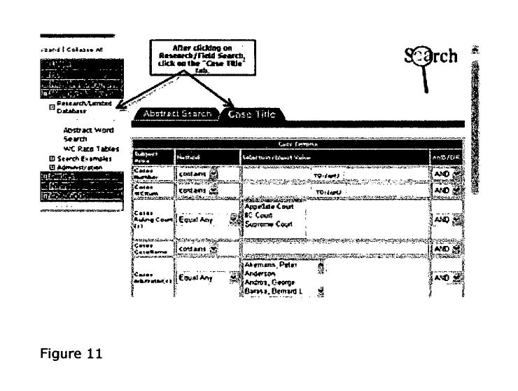

To initiate a search of the case information and ignore the abstract field attributes, based on pre-selected fields attributes, the case title tab can be selected. Referring to FIG. 11, a case title search screen is seen. The case title search screen can include as columns subject area, method, selection/input values, and and/or with a default of and. The case title search screen can include as rows the current case number, WC (workman's compensation or arbitration) number, ruling court, case party names, arbitrators, plaintiff firm(s), defendant firm(s), judge(s), industrial commission case reference, court cite, and commission panel members.

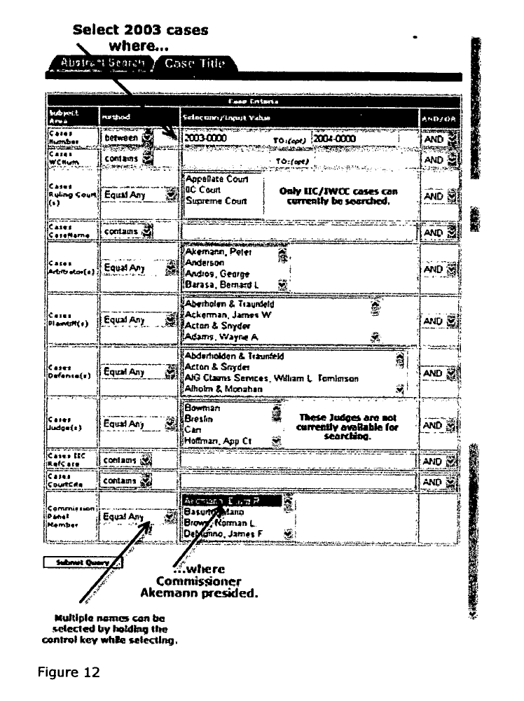

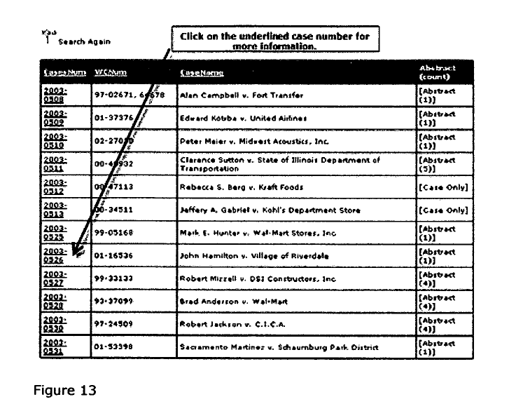

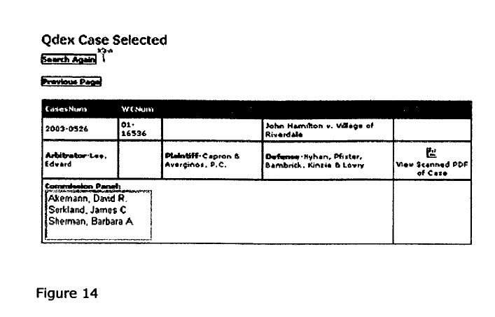

As with the abstract searching, by choosing search parameters different information can be secured. Referring to FIG. 12, an example case title search screen is seen. In this example, 2003 cases in which Commissioner Akemann presided are searched. Again, submit query is selected to initiate the search. An answer table for this example is seen in FIG. 13. By selecting a case, detailed case information can be displayed. Referring to FIG. 14, a case information screen for this example is seen.

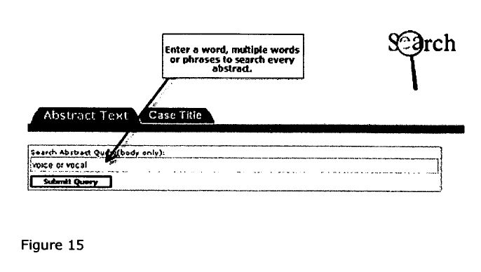

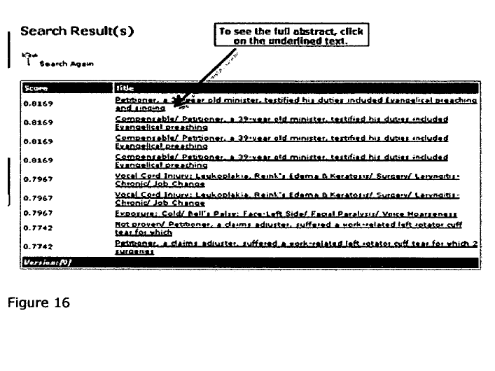

Referring back to FIG. 2, the navigation column is seen. To initiate a word search of the abstract, Abstract Word Search is selected. Referring to FIG. 15, an abstract text search page is seen. Boolean qualifiers such as, for example, “and” and “or” can be utilized. In the example seen in FIG. 15, the search is for abstracts containing either “voice” or “vocal.” Again, submit query is selected to initiate the search. An answer table for this second example is generated, as seen in FIG. 16. The answer tables for word searches have as columns a score and case title. The score indicates the frequency with which the search criterion appears in the abstract. Again, by selecting a case the full abstract can be displayed.

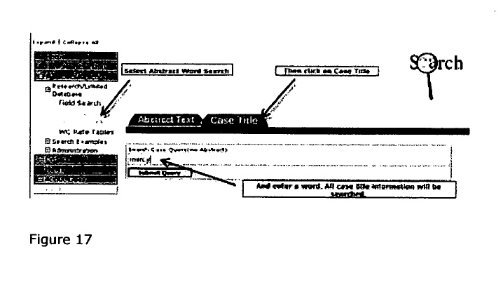

To initiate a word search of the case title information, the case title tab is selected. Referring to FIG. 17, a case title word search screen is seen. Boolean qualifiers such as, for example, “and” and “or” can be utilized. Again, submit query is selected to initiate the search. An answer table for this second example is generated. Again, by selecting a case the full abstract can be displayed.

While the invention has been described with specific embodiments, other alternatives, modifications, and variations will be apparent to those skilled in the art. Accordingly, it will be intended to include all such alternatives, modifications and variations set forth within the spirit and scope of the appended claims.

What is claimed is:

1. A method of searching legal databases comprising:
providing a matrix of pre-selected field attributes.

2. The method of searching legal databases of claim 1 further wherein the matrix comprising on a first axis parameters selected from a group of substantive subjects and comprising on a second axis parameters selected from a group of case information.

3. The method of searching legal databases of claim 2 further wherein the matrix comprises on a first axis subject area, method, selection/input value, and/or, and combinations thereof and comprising on a second axis chapter choice, case number, abstract text, abstract issue(s), abstract compensable, and combinations thereof.

4. The method of searching legal databases of claim 1 further wherein the matrix comprises search parameters, method of searching, selection/input value, the and/or option, and combinations thereof.

5. The method of searching legal databases of claim 1 further wherein the database can be searched based on a selected legal specialty chapter.

6. The method of searching legal databases of claim 1 further wherein the database can be searched based on workman's compensation chapters such as accident, causal connection, death, disfigurement, medical expenses, nature and extent, occupational disease, other issues, penalties and attorneys fees, section 19(H) Petitions, temp total disability, total permanent disability, and combinations thereof.

7. The method of searching legal databases of claim 1 further wherein the database can be searched based on a search term in text.

8. The method of searching legal databases of claim 1 further wherein the database can be searched based on a legal specialty issues within a legal specialty chapter.

9. The method of searching legal databases of claim 8 further wherein the database can be searched based on a workman's compensation issues within a workman's compensation chapter.

10. The method of searching legal databases of claim 1 further wherein the results of a database search are displayed based on legal specialty items.

11. The method of searching legal databases of claim 1 further wherein the results of a database search are displayed based on general fields legal specialty information and specific fields information specific to the search parameters.

12. The method of searching legal databases of claim 11 further wherein the displayed based on legal specialty items is linked to a text display.

13. A method of searching legal databases comprising:
selecting from a plurality of pre-selected fields wherein the pre-selected fields are selected from a group of substantive subjects and selected from a group of case information.

14. The method of searching legal databases of claim 13 further wherein the plurality of pre-selected fields attributes comprise a matrix of pre-selected field attributes.

15. The method of searching legal databases of claim 14 further wherein the matrix comprising on a first axis parameters selected from a group of substantive subjects and comprising on a second axis parameters selected from a group of case information.

16. The method of searching legal databases of claim 14 further wherein the matrix comprising on a first axis subject area, method, selection/input values, and/or, and combinations thereof, and comprising on a second axis number, workman's compensation number, ruling court, name, arbitrators, plaintiff(s), defendant(s), judge(s), industrial commission case reference, court cite, commissions panel members, and combinations thereof.

17. A method of searching legal databases based on case information comprising:
initiating a word search of the text; and
displaying results based on the frequency with which the search criterion appears in the text.

18. The method of searching legal databases of claim 17 further including initiating a Boolean word search of the text.
